(19) United States
(12) Patent Application Publication
(10) Pub. No.: US 2020/0163482 A1
(43) Pub. Date: May 28, 2020

(54) LIGHT-SHIELDING CURTAIN AND FABRIC

(71) Applicant: HANGZHOU CHINA HOME TEXTILES INDUSTRY CO., LTD., Zhejiang (CN)

(72) Inventor: Yingjun MA, Zhejiang (CN)

(73) Assignee: HANGZHOU CHINA HOME TEXTILES INDUSTRY CO., LTD., Zhejiang (CN)

(21) Appl. No.: 16/361,233

(22) Filed: Mar. 22, 2019

(30) Foreign Application Priority Data
Nov. 27, 2018 (CN) 201821968849.8

(51) Int. Cl. A47H 21/00; B32B 5/02; D03D 1/06; D03D 1/00; D03D 15/00; A47H 13/04

(52) U.S. Cl. CPC A47H 21/00; B32B 5/024; D03D 1/06; D10B 2401/22; D03D 15/0033; A47H 13/04; D03D 1/0017

(57) ABSTRACT

The invention relates to a light-shielding curtain and a fabric, belonging to the technical field of a machine-woven fabric. The light-shielding curtain includes a curtain head and a curtain body arranged under the curtain head, and at least the curtain body is made of a light-shielding fabric; the light-shielding fabric includes a first outer layer, a second outer layer, and a light-shielding film layer sandwiched between the first outer layer and the second outer layer, and the light-shielding film layer is a flexible film structure; and at least one of the first outer layer and the second outer layer is a woven layer woven by a warp thread and a weft thread. By arranging the light-shielding film layer between the first outer layer and the second outer layer, the light can be well shielded without additional light-shielding cloth; and one of the first outer layer and the second outer layer is the woven layer thereby ensuring a beautiful appearance, which is widely used in the field of home furnishing.

### CROSS-REFERENCE TO RELATED APPLICATION

This application claims the priority benefit of China application serial no. 201821968849.8, filed on Nov. 27, 2018. The entirety of the above-mentioned patent application is hereby incorporated by reference herein and made a part of this specification.

### BACKGROUND

### Technical Field

This invention relates to a machine-woven fabric, and more particularly to a light-shielding fabric and a curtain made of this fabric.

### Description of Related Art

By arranging a curtain at the inner side of the window, the curtain can not only isolate the external sight to protect the privacy indoors, but also isolate the sunlight in the summer to avoid direct sunlight which achieves heat insulation. When the light is relatively dim or the room temperature is relatively low, the indoor light and/or the room temperature will be supplemented by opening the curtain to obtain the sunlight.

In order to control the indoor light within a proper intensity range, the curtain having a light-shielding rate changes with the light intensity disclosed in a patent with the grant announcement number of CN207811985U is generally used. However, this curtain cannot be used in places where the requirement for the light-shielding rate is relatively high, and a strip of light-shielding cloth coated with silver power needs to be additionally used for light-shielding, making a hanging system of the curtain system complicated and not beautiful.

### SUMMARY

One purpose of this invention is to provide a curtain with an improved structure which can perform light-shielding without an extra light-shielding cloth.

Another purpose of this invention is to provide a fabric that can be used to make the above-mentioned curtain.

In order to achieve the above-mentioned purpose, a light-shielding curtain provided by this invention includes a curtain head and a curtain body arranged under the curtain head, and at least the curtain body is made of a light-shielding fabric; the light-shielding fabric includes a first outer layer, a second outer layer, and a light-shielding film layer sandwiched between the first outer layer and the second outer layer, and the light-shielding film layer is a flexible film structure; and at least one of the first outer layer and the second outer layer is a woven layer woven by a warp thread and a weft thread.

By arranging the light-shielding film layer between the first outer layer and the second outer layer, the light can be well shielded without additional light-shielding cloth; and one of the first outer layer and the second outer layer is the woven layer thereby ensuring a beautiful appearance.

A specific solution is that the light-shielding film layer is a TPU light-shielding film; a thickness of the TPU light-shielding film is in a range of 0.012 mm to 0.2 mm; the first outer layer, the light-shielding film layer, and the second outer layer are arranged sequentially to form a sandwich structure through hot-pressing on a whole surface; and the light-shielding film layer is a dark film structure. The TPU light-shielding film is used as the light-shielding film layer which achieves a good light-shielding effect.

A preferred solution is that the first outer layer and the second outer layer are both woven layers, and a front face of the first outer layer and a front face of the second outer layer are arranged toward directions away from the light-shielding film layer; the first outer layer is a cool color woven layer, and the second outer layer is warm color woven layer, and/or the pattern of the first outer layer and the pattern of the second outer layer are different. The first outer layer and the second outer layer are both woven layers, and the front side of each of the woven layers are arranged outwardly, such that two sides of this curtain are usable, and one of the two sides of this curtain can be chosen as the front side of the curtain thereby changing the pattern and color of the curtain.

Another preferred solution is that an edge portion at a top of the curtain body is detachably spliced at an edge portion at a bottom of the curtain head through a lateral flexible splicing assembly, which facilitates detachment between the curtain body and the curtain head, thereby facilitating operation such as replacement, detachment, and washing.

A more preferred solution is that the first outer layer and the second outer layer are both woven layers, and a front face of the first outer layer and a front face of the second outer layer are arranged toward directions away from the light-shielding film layer; and the lateral flexible splicing assembly includes a first splicing structure and a second splicing structure detachably spliced, the first splicing structure is fixedly disposed on one of the edge portion at the top of the curtain body and the edge portion at the bottom of the curtain head along a width direction of the curtain, and splicing interfaces of two of the second splicing structures are fixedly disposed on the other one of the edge portion at the top of the curtain body and the edge portion at the bottom of the curtain head oppositely. The first outer layer and the second outer layer are both woven layers, and the front side of each of the woven layers are arranged outwardly, such that two sides of this curtain are usable, and one of the two sides of this curtain can be chosen as the front side of the curtain thereby changing the pattern and color of the curtain.

A further solution is that one of the first splicing structure and the second splicing structure is a button, and the other one of the first splicing structure and the second splicing structure is a buttonhole, or one of the first splicing structure and the second splicing structure is a hook, and the other one of the first splicing structure and the second splicing structure is a hook support, or one of the first splicing structure and the second splicing structure is a strip of hook-and-loop cloth, and the other one of the first splicing structure and the second splicing structure is a hook-and-loop band with hooks.

A further solution is that a strip of hook-and-loop cloth is folded and fastened on the edge portion at the top of the curtain body, and a binding structure is formed by stitching the edge portion at the top of the curtain body through a thread; and the hook-and-loop cloth on two sides of the binding structure correspondingly constitutes two of the second splicing structures, and the first splicing structure is a hook-and-loop band with hooks. Part of the manual work and the use of the fabrics can be reduced during the manufacturing process.

A further solution is that in any one of an edge portion at one side of the curtain body, an edge portion at the other side of the curtain body, an edge portion at a bottom of the curtain body, an edge portion of one outer layer is folded 180 degrees relative to an edge portion of the other outer layer and is fastened on the edge portion of the other outer layer, and a binding structure of the edge portion of the other outer layer is formed by stitching. The overall appearance is better, which facilitates processing and reduces the manual workload.

In order to achieve the other above-mentioned purpose, a light-shielding fabric provided by this invention includes a first outer layer, a second outer layer, and a light-shielding film layer sandwiched between the first outer layer and the second outer layer, and the light-shielding film layer is a flexible film structure; and at least one of the first outer layer and the second outer layer is a woven layer woven by a warp thread and a weft thread.

A specific solution is that the light-shielding film layer is a TPU light-shielding film; a thickness of the TPU light-shielding film is in a range of 0.012 mm to 0.2 mm; the first outer layer, the light-shielding film layer, and the second outer layer are arranged sequentially to form a sandwich structure through hot-pressing on a whole surface; and the light-shielding film layer is a dark film structure.

### BRIEF DESCRIPTION OF THE DRAWINGS

FIG. 1 is a structural schematic diagram of a fabric in Embodiment One of the invention.

FIG. 2 is a manufacturing method for the fabric in Embodiment One of the invention.

FIG. 3A to FIG. 3C show a manufacturing method for a binding structure of the fabric in Embodiment One of the invention, FIG. 3A shows a structure of an edge portion of a first outer layer and a structure of an edge portion of a second outer layer after the fabric is hot-pressed, FIG. 3B is a diagram in which the edge portion of the first outer layer is bent such that the edge portion of the first outer layer is fastened at the edge portion of the second outer layer, and FIG. 3C a diagram in which the edge portion of the first outer layer is stitched at the edge portion of the second outer layer thereby forming the binding structure.

FIG. 4 is a three-dimensional diagram of a curtain and a curtain rod in Embodiment One of the invention.

FIG. 5 is a partial enlarged view of A in FIG. 4.

FIG. 6 is a structural schematic diagram of the curtain and the curtain rod in Embodiment One of the invention when a curtain body and a curtain head are detached;

FIG. 7 is a partial enlarged view of B in FIG. 6.

FIG. 8 is a schematic diagram of a connection structure between a curtain body and a curtain head in Embodiment Two of the invention.

FIG. 9 is a schematic diagram of a connection structure between a curtain body and a curtain head in Embodiment Three of the invention.

### DESCRIPTION OF THE EMBODIMENTS

This invention is further explained below in combination with the embodiments and the accompanying drawings.

### Embodiment One

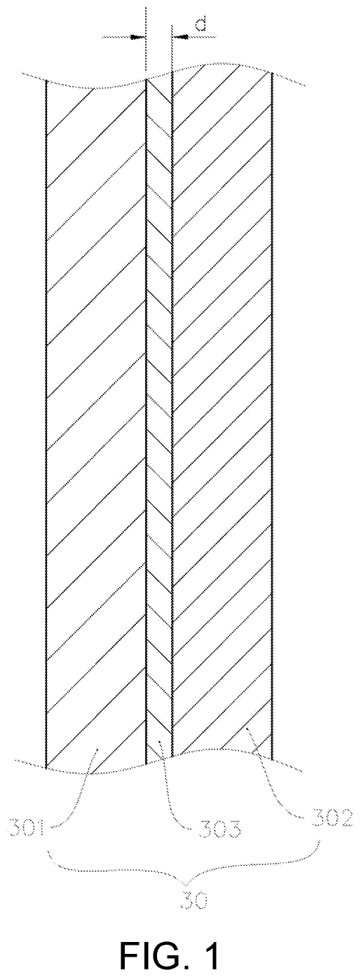

See FIG. 1 to FIG. 3, a light-shielding fabric 30 in this invention includes a first outer layer 301, a second outer layer 302, and a light-shielding film layer 303 sandwiched between the first outer layer 301 and the second outer layer 302. The light-shielding film layer 303 is a flexible film structure, and the specific material is an organic polymer having a molecular weight in a range of 16,000 to 100,000. A TPU light-shielding film is adopted in this invention, and a thickness d of the TPU light-shielding film is in a range of 0.012 mm to 0.2 mm, specifically 0.015 mm. Dark colors such as brown, black, and dark green are adopted. At least one of the first outer layer 301 and the second outer layer 302 is a woven layer woven by a warp thread and a weft thread, wherein the woven layer is a decorative layer. In this embodiment, both the first outer layer 301 and the second outer layer 302 are woven layers, and the front side of the first outer layer 301 and the front side of the second outer layer 302 are arranged outwardly. Therefore, this fabric is a double-sided usable fabric, and the curtain made of this fabric is usable on both sides. In order to make the curtain made of this fabric better adapt to the seasonal change, the first outer layer 301 is set into a cool color woven layer, while the second outer layer 302 is set into a warm color woven layer, such that different decorative sides with different colors can be replaced according to different seasons in order to adapt to the current season. Of course, the first outer layer 301 and the second outer layer 302 can be set into the same woven layer. In addition, the first outer layer 301 and the second outer layer 302 can be set into woven layers with different patterns, and the first outer layer 301 and the second outer layer 302 can also be set into woven layers not limited to different patterns and different colors.

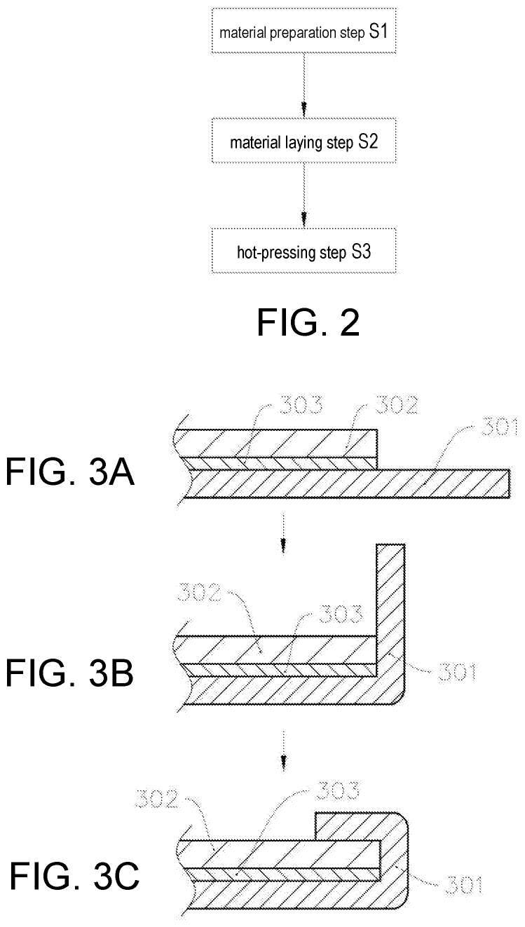

As shown in FIG. 2, a manufacturing method for this light-shielding fabric 30 includes a material preparation step S1, a material laying step S2, and a hot-pressing step S3.

Material preparation step S1: prepare the first outer layer 301, the second outer layer 302, and the TPU light-shielding film according to the sizes of the pre-hot-pressed fabrics.

The material of the first outer layer 301 and the material of the second outer layer 302 can be made of woven fabrics such as cotton, wool, silk, synthetic fiber and so on. Of course, one of the first outer layer 301 and the second outer layer 302 can be made of a non-woven fabric, and the other one of the first outer layer 301 and the second outer layer 302 can be made of a woven fabric.

Material laying step S2: lay the first outer layer 301, the TPU light-shielding film, and the second outer layer 302 in sequence in a fabric hot-pressing machine.

Hot-pressing step S3: perform hot-pressing at a hot-pressing temperature in a range of 115 degrees to 190 degrees, such that the first outer layer 301, the light-shielding film layer 303, and the second outer layer 302 arranged in sequence are laminated into a sandwich structure after the whole-face hot-pressing. The hot-pressing temperature is preferably in a range of 150 degrees to 190 degrees.

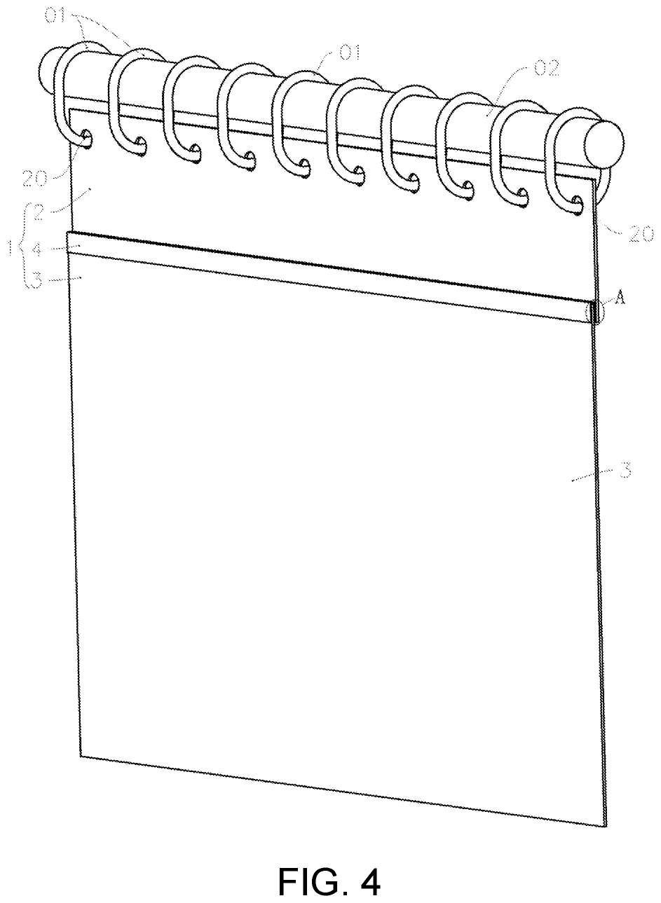

As shown in FIG. 3, in the material preparation step S1, according to the size of the curtain body to be made, at the bottom edge, the left edge, and the right edge, the size of the edge portion of the first outer layer 301 is larger than the size of the edge portion of the second outer layer 302. After hot-pressing, the structure shown in FIG. 3A in which the edge portion of the first outer layer 301 extends from the edge portion of the second outer layer 302 at the bottom edge, the left edge, and the right edge. As structures shown in FIG. 3B and FIG. 3C, the extended edge portion of the first outer layer 301 is bent and fastened on the edge portion of the second outer layer 302, and binding structures are formed at the bottom edge, the left edge, and the right edge by stitching.

See FIG. 4 to FIG. 7. A curtain 1 of this invention includes a curtain head 2, a curtain body 3, and a lateral flexible splicing assembly 4 detachably splicing the curtain head 2 and the curtain body 3. The curtain head 2 is provided with one row of holes 20 arranged along the width direction of the curtain head 2, and the curtain head 2 can be hung on a curtain rod 02 in a folded and flexible way through O-shaped rings 01 passing through holes 20.

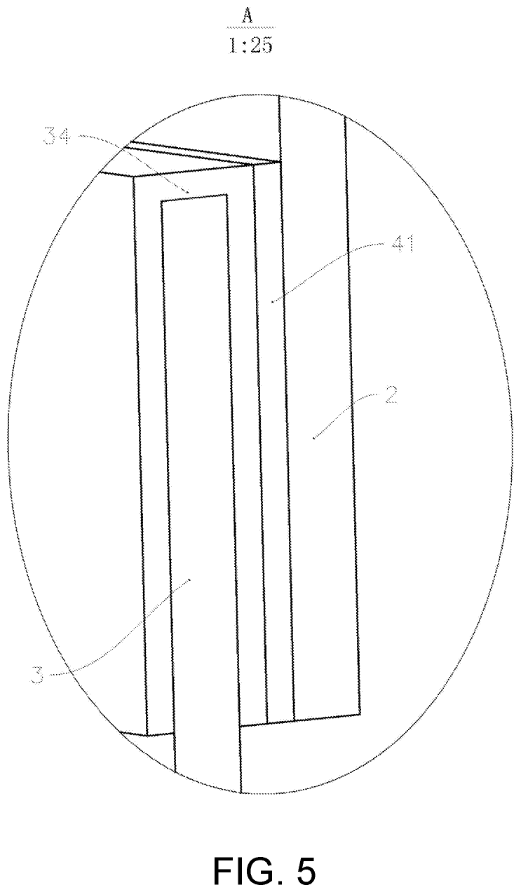

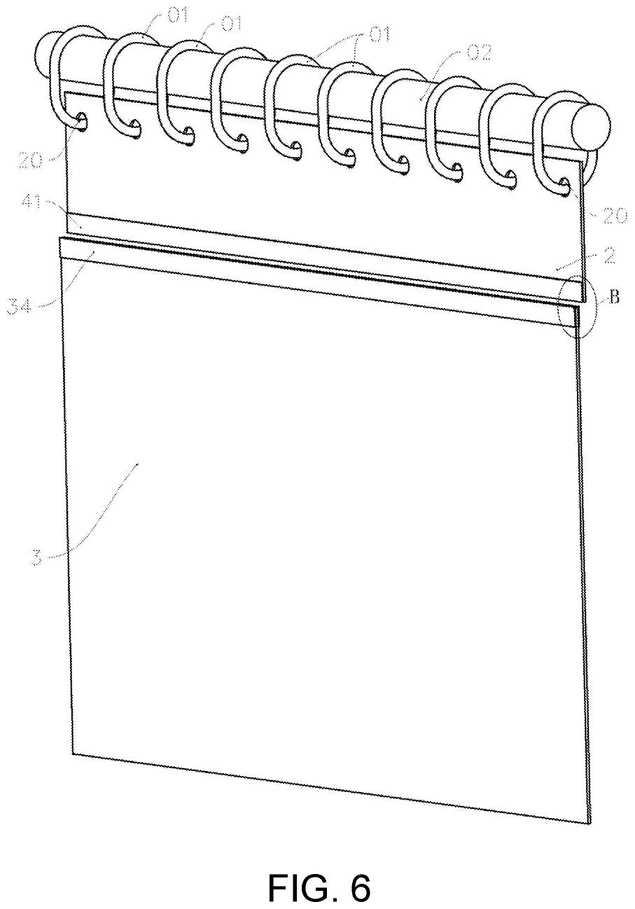

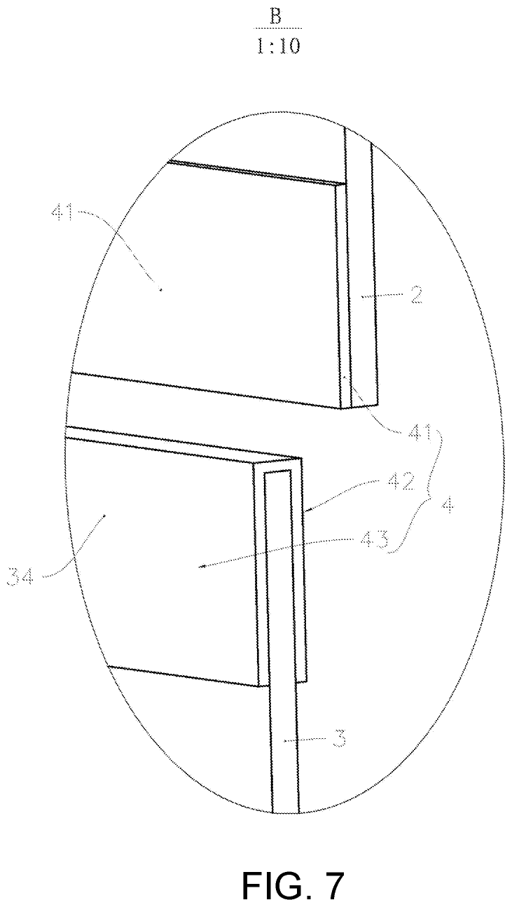

As shown in FIG. 5 and FIG. 7, a strip of hook-and-loop cloth 34 is folded and fastened on the edge portion at the top of the light-shielding fabric 30, and the binding structure is formed by stitching the edge portion at the top of the light-shielding fabric 30 through the thread.

As shown in FIG. 4 to FIG. 7, the lateral flexible splicing assembly 4 includes a hook-and-loop band 41 with hooks and a hook-and-loop cloth face 42 and a hook-and-loop cloth face 43 facing opposite directions. The hook-and-loop band 41 is stitched on the light-facing side of an edge portion at the bottom of the curtain head 2 through the thread. The hook-and-loop cloth face 42 and the hook-and-loop cloth face 43 correspond to two outer faces after the strip of the hook-and-loop cloth 34 is bent into a U-shaped structure. As a fastening face of the strip of the hook-and-loop cloth 34 is full of soft fiber loops, and the hook-and-loop band 41 is full of hooks, the strip of the hook-and-loop cloth 34 and the hook-and-loop band 41 are detachably fastened, and foldable flexibility is kept after fastening. Therefore, by fastening the hook-and-loop band 41 with one of the hook-and-loop cloth faces, one of the first outer layer 301 and the second outer layer 302 is used as the front face of the curtain, that is, the edge portion at the top the curtain body 3 is detachably spliced at the edge portion at the bottom of the curtain head 2 through the lateral flexible splicing assembly 4.

The hook-and-loop band 41 is arranged at the light-facing side of the curtain head 2, such that the lateral flexible splicing assembly 4 can be well hidden when the curtain 1 is viewed from the front, and the whole lateral flexible splicing assembly 4 is located at the curtain head 2, effectively ensuring the overall beauty of the curtain 1. The hook-and-loop cloth face 42 and the hook-and-loop cloth face 43 are second splicing structures in this embodiment, and the hook-and-loop band 41 is the first splicing structure in this embodiment.

### Embodiment Two

As an illustration of Embodiment Two of this invention, only the differences from the above-mentioned Embodiment One will be described below.

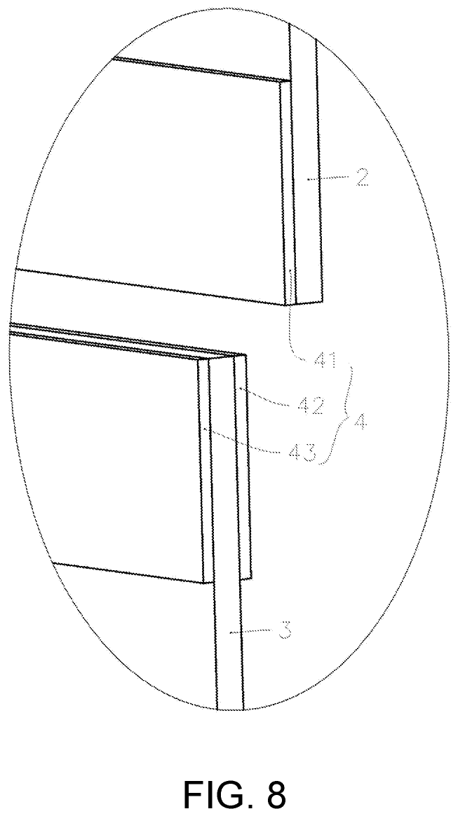

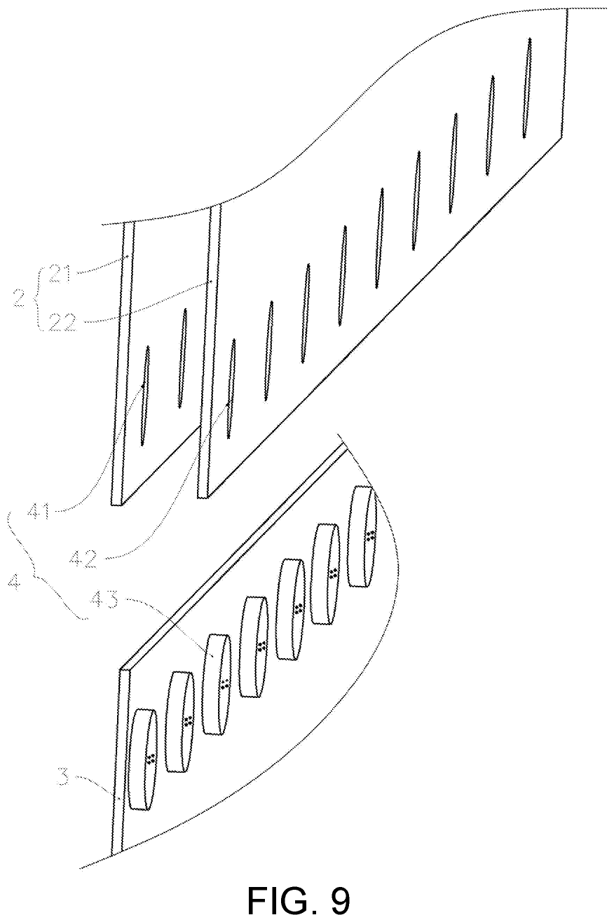

As shown in FIG. 8, a hook-and-loop band 42 and a hook-and-loop band 43 are stitched at two sides of the edge portion at the top of the curtain body 3, respectively, a strip of hook-and-loop cloth 41 is stitched at the edge portion at the bottom of the curtain head 2, and the strip of hook-and-loop cloth 41 is located at the light-facing side of the curtain head 2, thereby forming the lateral flexible splicing assembly 4. The hook-and-loop band 42 and the hook-and-loop band 43 are second splicing structures in this embodiment, and the strip of the hook-and-loop cloth 41 is the first splicing structure in this embodiment.

### Embodiment Three

As an illustration of Embodiment Three of this invention, only the differences from the above-mentioned Embodiment One will be described below.

See FIG. 9. The curtain head 2 is stitched by a fabric 21 and a fabric 22 freely separated at the edge portion of the bottom. One row of buttonholes 41 are arranged at the edge portion at the bottom of the fabric 21, and one row of buttonholes 42 are arranged at the edge portion at the bottom of the fabric 22. One row of buttons 43 matching with buttonholes 41 and buttonholes 42 are stitches at the edge portion at the top of the curtain body 3, and the row of buttons 43 and two rows of buttonholes 41, 42 form the lateral flexible splicing assembly 4 in this embodiment. The buttonholes 42 and buttonholes 43 are second splicing structures in this embodiment, and buttons 43 are the first splicing structures in this embodiment.

In this invention, the “lateral flexible splicing assembly” is configured as a connecting assembly structure detachably connecting the curtain head and the curtain body and a flexible structure laterally folding the curtain when the curtain is closed.

What is claimed is:

1. A light-shielding curtain, comprising a curtain head and a curtain body arranged under the curtain head, at least the curtain body being made of a light-shielding fabric, wherein the light-shielding fabric comprises a first outer layer, a second outer layer, and a light-shielding film layer sandwiched between the first outer layer and the second outer layer, and the light-shielding film layer is a flexible film structure; and at least one of the first outer layer and the second outer layer is a woven layer woven by a warp thread and a weft thread.

2. The light-shielding curtain as recited in claim 1, wherein the light-shielding film layer is a TPU light-shielding film; a thickness of the TPU light-shielding film is in a range of 0.012 mm to 0.2 mm; the first outer layer, the light-shielding film layer, and the second outer layer are arranged sequentially to form a sandwich structure through hot-pressing on a whole surface; and the light-shielding film layer is a dark film structure.

3. The light-shielding curtain as recited in claim 1, wherein a front face of the first outer layer and a front face of the second outer layer are arranged toward directions away from the light-shielding film layer; and the first outer layer and the second outer layer are woven layers having different color and/or woven layers having different patterns.

4. The light-shielding curtain as recited in claim 1, wherein an edge portion at a top of the curtain body is detachably spliced at an edge portion at a bottom of the curtain head through a lateral flexible splicing assembly.

5. The light-shielding curtain as recited in claim 4, wherein the first outer layer and the second outer layer are both woven layers, and a front face of the first outer layer and a front face of the second outer layer are arranged toward directions away from the light-shielding film layer; and the lateral flexible splicing assembly comprises a first splicing structure and a second splicing structure detachably spliced, the first splicing structure is fixedly disposed on one of the edge portion at the top of the curtain body and the edge portion at the bottom of the curtain head along a width direction of the curtain, and splicing interfaces of two of the second splicing structures are fixedly disposed on the other one of the edge portion at the top of the curtain body and the edge portion at the bottom of the curtain head oppositely.

6. The light-shielding curtain as recited in claim 5, wherein one of the first splicing structure and the second splicing structure is a button, and the other one of the first splicing structure and the second splicing structure is a buttonhole, or one of the first splicing structure and the second splicing structure is a hook, and the other one of the first splicing structure and the second splicing structure is a hook support, or one of the first splicing structure and the second splicing structure is a strip of hook-and-loop cloth, and the other one of the first splicing structure and the second splicing structure is a hook-and-loop band with hooks.

7. The light-shielding curtain as recited in claim 5, wherein a strip of hook-and-loop cloth is folded and fastened on the edge portion at the top of the curtain body, and a binding structure is formed by stitching the edge portion at the top of the curtain body through a thread; and the hook-and-loop cloth on two sides of the binding structure correspondingly constitutes two of the second splicing structures, and the first splicing structure is a hook-and-loop band with hooks.

8. The light-shielding curtain as recited in claim 5, wherein in any one of an edge portion at one side of the curtain body, an edge portion at the other side of the curtain body, an edge portion at a bottom of the curtain body, an edge portion of one outer layer is folded 180 degrees relative to an edge portion of the other outer layer and is fastened on the edge portion of the other outer layer, and a binding structure of the edge portion of the other outer layer is formed by stitching.

9. The light-shielding curtain as recited in claim 2, wherein a front face of the first outer layer and a front face of the second outer layer are arranged toward directions away from the light-shielding film layer; and the first outer layer and the second outer layer are woven layers having different color and/or woven layers having different patterns.

10. The light-shielding curtain as recited in claim 2, wherein an edge portion at a top of the curtain body is detachably spliced at an edge portion at a bottom of the curtain head through a lateral flexible splicing assembly.

11. The light-shielding curtain as recited in claim 10, wherein the first outer layer and the second outer layer are both woven layers, and a front face of the first outer layer and a front face of the second outer layer are arranged toward directions away from the light-shielding film layer; and the lateral flexible splicing assembly comprises a first splicing structure and a second splicing structure detachably spliced, the first splicing structure is fixedly disposed on one of the edge portion at the top of the curtain body and the edge portion at the bottom of the curtain head along a width direction of the curtain, and splicing interfaces of two of the second splicing structures are fixedly disposed on the other one of the edge portion at the top of the curtain body and the edge portion at the bottom of the curtain head oppositely.

12. The light-shielding curtain as recited in claim 11, wherein one of the first splicing structure and the second splicing structure is a button, and the other one of the first splicing structure and the second splicing structure is a buttonhole, or one of the first splicing structure and the second splicing structure is a hook, and the other one of the first splicing structure and the second splicing structure is a hook support, or one of the first splicing structure and the second splicing structure is a strip of hook-and-loop cloth, and the other one of the first splicing structure and the second splicing structure is a hook-and-loop band with hooks.

13. The light-shielding curtain as recited in claim 11, wherein a strip of hook-and-loop cloth is folded and fastened on the edge portion at the top of the curtain body, and a binding structure is formed by stitching the edge portion at the top of the curtain body through a thread; and the hook-and-loop cloth on two sides of the binding structure correspondingly constitutes two of the second splicing structures, and the first splicing structure is a hook-and-loop band with hooks.

14. The light-shielding curtain as recited in claim 11, wherein in any one of an edge portion at one side of the curtain body, an edge portion at the other side of the curtain body, an edge portion at a bottom of the curtain body, an edge portion of one outer layer is folded 180 degrees relative to an edge portion of the other outer layer and is fastened on the edge portion of the other outer layer, and a binding structure of the edge portion of the other outer layer is formed by stitching.

15. A light-shielding fabric, comprising a first outer layer, a second outer layer, and a light-shielding film layer sandwiched between the first outer layer and the second outer layer, wherein the light-shielding film layer is a flexible film structure; and at least one of the first outer layer and the second outer layer is a woven layer woven by a warp thread and a weft thread.

16. The light-shielding fabric as recited in claim 15, wherein the light-shielding film layer is a TPU light-shielding film; a thickness of the TPU light-shielding film is in a range of 0.012 mm to 0.2 mm; the first outer layer, the light-shielding film layer, and the second outer layer are arranged sequentially to form a sandwich structure through hot-pressing on a whole surface; and the light-shielding film layer is a dark film structure.
